(19) United States
(12) Patent Application Publication
(10) Pub. No.: US 2017/0173854 A1
(43) Pub. Date: Jun. 22, 2017

(54) THERMOPLASTIC SHAPE MEMORY MATERIAL

(71) Applicant: BASF SE, Ludwigshafen (DE)

(72) Inventors: Stefan BOKERN, Bremen (DE); Frank PRISSOK, Lemfoerde (DE); Sebastian HARTWIG, Muenster (DE); Elmar POESELT, Hamburg (DE); Julia GOESCHEL, Bremen (DE)

(73) Assignee: BASF SE, Ludwigshafen (DE)

(21) Appl. No.: 15/129,540

(22) PCT Filed: Mar. 11, 2015
(86) PCT No.: PCT/EP15/55044

§ 371 Date: Sep. 27, 2016

(30) Foreign Application Priority Data
Mar. 27, 2014 (EP) 14161941.1

(51) Int. Cl. B29C 61/00; C08G 18/48; C08G 18/75; C08G 18/66; C08G 18/42; C08G 18/24; C08G 18/32; B29C 61/06; C08G 18/76

(52) U.S. Cl. CPC B29C 61/003; B29C 61/06; C08G 18/4825; C08G 18/4879; C08G 18/758; C08G 18/7671; C08G 18/4244; C08G 18/244; C08G 18/3206; C08G 18/6681; B29K 2075/00

(57) ABSTRACT

The present invention relates to a process for producing a shaped body (SB) comprising the preparation of a thermoplastic polyurethane, the production of a shaped body (SB*) from the thermoplastic polyurethane, the heating of the shaped body (SB*) to a temperature below the temperature of permanent deformability of the shaped body (SB*) and above the switching temperature of the thermoplastic polyurethane, the expanding of the heated shaped body (SB*) to obtain a shaped body (SB), and the cooling of the shaped body (SB) to a temperature below the switching temperature of the thermoplastic polyurethane, and to the shaped bodies obtained or obtainable by such a process. The present invention further relates to the use of a thermoplastic polyurethane for production of a shaped body having shape memory effect within a temperature range from 20° C. to 120° C.

The present invention relates to a process for producing a shaped body (SB) comprising the preparation of a thermoplastic polyurethane, the production of a shaped body (SB*) from the thermoplastic polyurethane, the heating of the shaped body (SB*) to a temperature below the temperature of permanent deformability of the shaped body (SB*) and above the switching temperature of the thermoplastic polyurethane, the expanding of the heated shaped body (SB*) to obtain a shaped body (SB), and the cooling of the shaped body (SB) to a temperature below the switching temperature of the thermoplastic polyurethane, and to the shaped bodies obtained or obtainable by such a process. Switching temperature is understood to mean the temperature at which a phase transition below the melting temperature of the hard phase is understood. This may be a glass transition or a melt transition from semicrystalline or fully crystalline structures. The present invention further relates to the use of a thermoplastic polyurethane for production of a shaped body having shape memory effect within a temperature range from 20° C. to 120° C.

Thermoplastic polyurethanes for various applications are known in principle from the prior art. By the variation of the feedstocks, it is possible to obtain different profiles of properties.

Thermoplastic polyurethanes that exhibit a shape memory effect are also known per se. The shape memory effect is usually based on soft phase crystallization of polyester polyols. The polyurethanes based on polyester polyols have the disadvantage of instability to hydrolysis and aggressive chemicals such as strong acids and bases, which greatly restricts their usability, for example for outdoor applications. Alternatively, the shape memory effect can also be established through the use of blends. However, these are complex to produce and are not phase-stable. A further approach to achieving a shape memory effect is the use of nanostructured polyols, but the synthesis of these is likewise complex.

JP 2005102953 describes a non-thermoplastic shape memory resin for fitting of teeth, which permits later corrections. The resin is either polyurethane-, polyurethaneurea-, polynorbornene-, t-polyisoprene- or styrene/butadiene-based and has a glass transition temperature between 40 and 100° C. (preferably 60 to 80° C.).

WO 2011/060970 or the parallel US 20120279101 A1 also discloses a shape memory TPU based on polyester polyols. These are not hydrolysis-stable. Bisphenol A-based compounds are used as chain extenders for the hard phase. As chain extenders in the hard phase, these exhibit disadvantages in terms of the mechanical properties.

U.S. Pat. No. 7,524,914 B2 describes the production of a shape memory TPU through the use of a dihydroxyl-terminated polyhedral oligosilsesquioxane. This is difficult to prepare.

Proceeding from the prior art, it was an object of the present invention to provide a thermoplastic polyurethane having shape memory effect which is stable to chemicals such as dilute hydrochloric acid. It was a further object of the present invention to provide a thermoplastic polyurethane having shape memory effect which is stable to chemicals such as dilute hydrochloric acid and which is simple and inexpensive to produce in a one-shot process.

This object is achieved in accordance with the invention by a process for producing a shaped body (SB) comprising the following steps:
(a) preparing a thermoplastic polyurethane comprising the conversion of
   (i) at least one polyisocyanate composition;
   (ii) at least one chain extender; and
   (iii) at least one polyol composition,
   where the polyol composition comprises at least one bisphenol derivative selected from the group consisting of bisphenol A derivatives having a molecular weight Mw>315 g/mol and bisphenol S derivatives having a molecular weight Mw>315 g/mol, where at least one of the OH groups of the bisphenol derivative has been alkoxylated;
(b) producing a shaped body (SB*) from the thermoplastic polyurethane,
(c) heating the shaped body (SB*) to a temperature below the temperature of permanent deformability of the shaped body (SB*) and above the switching temperature of the thermoplastic polyurethane,
(d) expanding the heated shaped body (SB*) to obtain a shaped body (SB),
(e) cooling the shaped body (SB) to a temperature below the switching temperature of the thermoplastic polyurethane.

It has been found that, surprisingly, the process of the invention and the use of a thermoplastic polyurethane based on bisphenol-based monomers in conjunction with a polyol, chain extender and diisocyanate give shaped bodies having shape memory effect.

According to the invention, the thermoplastic polyurethane may especially be a compact thermoplastic polyurethane. Accordingly, the present invention, in a further embodiment, relates to a process as described above, wherein the thermoplastic polyurethane is a compact thermoplastic polyurethane.

In the process of the invention, the shaped body (SB*) produced from the thermoplastic polyurethane is first expanded (for example inflated) at a temperature above the switching temperature and, in the expanded state, cooled down to a temperature below the switching temperature. This affords a shaped body (SB) which is expanded with respect to the shaped body (SB*) and is stable in this expanded state. The expansion of the material has thus been “frozen in”. As a result of a reheating of the shaped body (SB) to a temperature above the switching temperature, the TPU or the shaped body is deformed very rapidly back to its original size, i.e. to the size of the unexpanded shaped body (SB*). In this case, as a result of the process, a residual expansion of up to 20% may remain.

The process of the invention comprises steps (a) to (e). First of all, in step (a), a thermoplastic polyurethane is prepared by converting at least one polyisocyanate composition, at least one chain extender and at least one polyol composition. According to the invention, the polyol composition comprises at least one bisphenol derivative selected from the group consisting of bisphenol A derivatives having a molecular weight Mw>315 g/mol and bisphenol S derivatives having a molecular weight Mw>315 g/mol, where at least one of the OH groups of the bisphenol derivative has been alkoxylated.

In step (b), the thermoplastic polyurethane obtained in step (a) is used to produce a shaped body (SB*). The shaped body (SB*) may, in the context of the present invention, for example, also be a film. In this case, the production of the shaped body (SB*) in the context of the present invention can be effected by all customary methods, for example by extrusion, injection molding or sintering methods.

In a further embodiment, the present invention accordingly relates to a process as described above, wherein the shaped body (SB*) is produced in step (b) by means of extrusion, injection molding or sintering methods.

In step (c) of the process of the invention, the shaped body (SB*) is heated to a temperature below the temperature of permanent deformability of the shaped body (SB*), i.e., for example, to a temperature below the melting point and above the switching temperature of the thermoplastic polyurethane.

In a further embodiment, the present invention accordingly relates to a process as described above, wherein the commencement of permanent deformability corresponds to the commencement of the melting of the hard phase of the thermoplastic polyurethane, and the switching temperature to the commencement of the highest phase transition in terms of temperature before the melting range.

Suitable thermoplastic polyurethanes have, for example, a melting temperature in the range from 140 to 250° C., preferably in the range from 160 to 230° C.

Suitable thermoplastic polyurethanes have, for example, a switching temperature in the range from 20 to 120° C., preferably in the range from 30 to 110° C., more preferably in the range from 35 to 100° C.

In a further embodiment, the present invention accordingly relates to a process as described above, wherein the switching temperature of the thermoplastic polyurethane (T_{switch}) is in the range from 20 to 120° C.

According to the invention, the heating can be effected by any suitable method known to those skilled in the art. The heating is preferably effected by electrical heating, heating via heated oil or water, induction fields, warm air, IR radiation or high-energy radiation (laser).

The shaped body (SB*) which has been heated in step (c) of the process of the invention is expanded in step (d) of the process. According to the invention, the shaped body can be expanded in one, two or three dimensions. It is possible for the shaped body to be stretched, especially when the shaped body is a film, or else inflated. After the expansion, the extent of the shaped body in at least one dimension is greater than before the expansion. The expansion of the shaped body (SB) obtained in step (d), preferably in at least one dimension, is at least 150% of the extent of the shaped body (SB*), further preferably at least 200% of the extent of the shaped body (SB*). The expansion in one dimension may also be caused by compression in another dimension.

In a further embodiment, the present invention accordingly relates to a process as defined above, wherein the expansion of the shaped body (SB) obtained in step (d) in at least one dimension is at least 150% of the extent of the shaped body (SB*).

According to the invention, the shaped body (SB*) has sufficient wall thickness to assure the expansion in step (d). In the course of expansion of the shaped body, the wall thickness may become lower.

In step (e), the expanded shaped body (SB) is then cooled down to a temperature below the switching temperature of the thermoplastic polyurethane. According to the invention, the extent of the shaped body (SB) remains essentially constant. According to the invention, after cooling and relaxation in step (e), direct shrinkage of less than 15% or no shrinkage occurs.

It has been found that a shaped body (SB) obtained by a process according to the invention has a shape memory effect. According to the invention, this is achieved by virtue of the specific process regime in combination with the thermoplastic polyurethane used in accordance with the invention.

Thus, in accordance with the invention, the extent of the shaped body (SB) obtained, on cooling to temperatures below the switching temperature, may remain essentially constant and, on subsequent heating above the glass transition, relax by at least 20%, meaning that the shaped body shrinks. The maximum degree of relaxation in the extent on heating to a temperature above the switching temperature is the original extent.

It is essential in the context of the present invention that, in the production of the thermoplastic polyurethane in step (a), at least one chain extender and the polyol composition as described above are used. The polyol composition, as well as the at least one bisphenol derivative, may comprise further polyols. Accordingly, in the context of the present invention, it is also possible to use at least one chain extender and a polyol composition comprising at least one bisphenol A derivative as described above and at least one further polyol.

According to the invention, it is possible to use one chain extender, but it is also possible to use mixtures of different chain extenders.

Chain extenders used in the context of the present invention may, for example, be compounds having hydroxyl or amino groups, especially having 2 hydroxyl or amino groups. According to the invention, however, it is also possible that mixtures of different compounds are used as chain extenders. According to the invention, the mean functionality of the mixture is 2.

Preferably in accordance with the invention, chain extenders used are compounds having hydroxyl groups, especially diols. Diols used with preference may be aliphatic, araliphatic, aromatic and/or cycloaliphatic diols having a molecular weight of 50 g/mol to 220 g/mol.

Preference is given to alkanediols having 2 to 10 carbon atoms in the alkylene radical, especially di-, tri-, tetra-, penta-, hexa-, hepta-, octa-, nona- and/or decaalkylene glycols. For the present invention, particular preference is given to 1,2-ethylene glycol, propane-1,3-diol, butane-1,4-diol, hexane-1,6-diol. It is also possible to use aromatic compounds such as hydroxyquinone bis(2-hydroxyethyl) ether.

According to the invention, it is also possible to use compounds having amino groups, for example diamines. It is likewise possible to use mixtures of diols and diamines.

Preferably, the chain extender is a diol having a molecular weight Mw<220 g/mol. According to the invention, it is possible that only one diol having a molecular weight Mw<220 g/mol is used for preparation of the transparent thermoplastic polyurethane.

In a further embodiment, more than one diol is used as chain extender. It is thus also possible to use mixtures of chain extenders, where at least one diol has a molecular weight Mw<220 g/mol. If more than one chain extender is used, the second or further chain extender may also have a molecular weight≧220 g/mol.

In a further embodiment, the chain extender is selected from the group consisting of butane-1,4-diol and hexane-1,6-diol.

In a further embodiment, the present invention accordingly relates to a process as described above, wherein the chain extender used in (i) in step (a) of the process of the invention is a diol having a molecular weight Mw<220 g/mol.

The chain extender, especially the diol having a molecular weight Mw<220 g/mol, is preferably used in a molar ratio in the range from 40:1 to 1:10 to the bisphenol derivative. Preferably, the chain extender and the bisphenol derivative are used in a molar ratio in the range from 20:1 to 1:9, further preferably in the range from 10:1 to 1:8.5, for example in the range from 5:1 to 1:5, or else in the range from 4:1 to 1:1, further preferably in the range from 3:1 to 2:1.

In a further embodiment, the present invention accordingly relates to a process as described above, wherein the chain extender used in (i) and the bisphenol derivative present in the polyol composition are used in a molar ratio of 40:1 to 1:10.

According to the invention, the polyol composition comprises at least one bisphenol derivative, selected from the group consisting of bisphenol A derivatives having a molecular weight Mw>315 g/mol and bisphenol S derivatives having a molecular weight Mw>315 g/mol, where at least one of the OH groups of the bisphenol derivative has been alkoxylated. According to the invention, it is also possible that the polyol composition comprises two or more bisphenol derivatives, selected from the group consisting of bisphenol A derivatives having a molecular weight Mw>315 g/mol and bisphenol S derivatives having a molecular weight Mw>315 g/mol, where at least one of the OH groups of the bisphenol derivative has been alkoxylated.

In a preferred embodiment of the present invention, the at least one bisphenol derivative has only primary OH groups. Thus, in this embodiment, the at least one bisphenol derivative does not have any phenolic or aromatic OH groups.

According to the invention, at least one of the OH groups of the bisphenol derivative has been alkoxylated. In a preferred embodiment of the present invention, both OH groups of the bisphenol derivative have been alkoxylated. It has been found that, surprisingly, by virtue of the inventive combination of polyols and the use of bisphenol derivatives in which at least one of the OH groups has been alkoxylated, preferably both OH groups have been alkoxylated, and in which there are preferably thus no aromatic OH groups present, the inventive shape memory properties of the resulting thermoplastic polyurethane are obtained.

In a further embodiment of the present invention, both OH groups of the bisphenol derivative have been alkoxylated. According to the present invention, alkoxylated means that an alkoxy group (—O—R— with R=alkylene radical) is incorporated into the chemical bond between the aromatic ring of the bisphenol derivative and the hydroxyl group. In one embodiment, the two OH groups on the bisphenol derivative have been alkoxylated with the same alkoxy group. It is possible, for example, that the OH groups have been alkoxylated with ethoxy (—O—O₂H₄—), propoxy (—O—O₃H₆—), butoxy (—O—O₄H₈—), pentoxy (—O—O₅H₁₀—) or hexoxy groups (—O—O₆H₁₂—).

In a further embodiment of the present invention, both OH groups of the bisphenol derivative have been alkoxylated with different alkoxy groups (—O—R— with R=alkylene radical). In a preferred embodiment, the two OH groups of the bisphenol derivative have been alkoxylated with two different radicals selected from the group consisting of ethoxy (—O—C₂H₄—), propoxy (—O—C₃H₆—), butoxy (—O—C₄H₈—), pentoxy (—O—O₅H₁₀—) or hexoxy radical (—O—C₆H₁₂—).

According to the invention, the alkoxy radical may have one or else more than one alkoxy group. In a preferred embodiment of the present invention, a bisphenol derivative is used, where at least one of the OH groups of the bisphenol derivative has been alkoxylated, and the at least one alkoxy radical has a molecular weight of >40 g/mol, preferably >60 g/mol, further preferably >120 g/mol, especially >180 g/mol, for example >250 g/mol or else >300 g/mol.

In a further-preferred embodiment of the present invention, a bisphenol derivative is used, where both OH groups of the bisphenol derivative have been alkoxylated, and the two alkoxy radicals may be the same or different and independently have a molecular weight of >40 g/mol, preferably >60 g/mol, further preferably >120 g/mol, especially >180 g/mol, for example >250 g/mol or else >300 g/mol.

According to the invention, the bisphenol derivative is selected from the group consisting of bisphenol A derivatives having a molecular weight Mw>315 g/mol and bisphenol S derivatives having a molecular weight Mw>315 g/mol, where at least one of the OH groups of the bisphenol derivative has been alkoxylated. Preference is further given to bisphenol A derivatives or bisphenol S derivatives having a molecular weight Mw>400 g/mol, further preferably a molecular weight Mw>450 g/mol, especially a molecular weight Mw>500 g/mol, more preferably a molecular weight Mw>550 g/mol, for example a molecular weight Mw>600 g/mol.

In one embodiment, the present invention relates to a thermoplastic polyurethane as described above, wherein the at least one bisphenol derivative has only primary OH groups.

One example of a bisphenol derivative suitable in accordance with the invention has the following general formula (I):

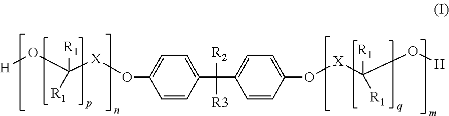

where
R1 is in each case independently a methyl group or H,
R2 and R3 are a methyl group or
R2-C—R3 together are O═S═O,
X is a —C(R1)₂-, —C(R1)₂-C(R1)₂- or —C(R1)₂-C(R1)₂-C(R1)₂- group,
p and q are independently an integer from 1 to 4, and
n and m are independently an integer >0.

According to the invention, the bisphenol derivative may have the formula (Ia) where R2 and R3 are a methyl group, or (Ib) where R2-C—R3 together are O═S═O:

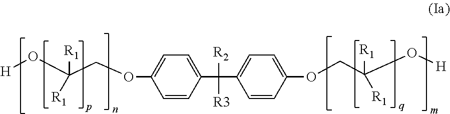

where
R1 is in each case independently a methyl group or H,
R2 and R3 are a methyl group,
X is a —C(R1)₂-, —C(R1)₂-C(R1)₂- or —C(R1)₂-C(R1)₂-C(R1)₂- group,
p and q are independently an integer from 1 to 4, and
n and m are independently an integer >0;
   or

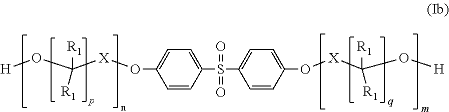

where
R1 is in each case independently a methyl group or H,
R2-C—R3 together are O═S═O,
X is a —C(R1)₂-, —C(R1)₂-C(R1)₂- or —C(R1)₂-C(R1)₂-C(R1)₂- group,
p and q are independently an integer from 1 to 4, and
n and m are independently an integer >0.

In a preferred embodiment, the alkoxy radical in each case is an ethoxy radical, meaning that, in a preferred embodiment, the at least one bisphenol derivative has the general formula (II):

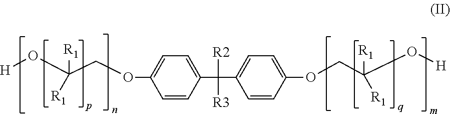

where
R1 is in each case independently a methyl group or H,
R2 and R3 are a methyl group or
R2-C—R3 together are O═S═O,
p and q are independently an integer from 1 to 4, and
n and m are independently an integer >0.

In a further embodiment, the present invention accordingly relates to a process as described above, wherein the at least one bisphenol derivative has the following general formula (I):

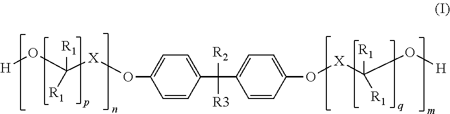

where
R1 is in each case independently a methyl group or H,
R2 and R3 are a methyl group or
R2-C—R3 together are O═S═O,
X is a —C(R1)₂-, —C(R1)₂-C(R1)₂- or —C(R1)₂-C(R1)₂-C(R1)₂- group,
p and q are independently an integer from 1 to 4, and
n and m are independently an integer >0.

In a further embodiment, the present invention also relates to a process as described above, wherein the at least one bisphenol derivative has only primary OH groups.

In a preferred embodiment, R1 is hydrogen, meaning that the compound of the formula (I) or (Ia), (Ib) or (II) preferably has primary alcohol groups in the terminal position.

As well as the at least one bisphenol derivative, the polyol composition may, in accordance with the invention, comprise further polyols. In a further embodiment, the present invention accordingly relates to a process as described above, wherein the polyol composition comprises a polyol selected from the group consisting of polyetherols, polyesterols, polycarbonate alcohols and hybrid polyols.

Polyols are known in principle to those skilled in the art and are described, for example, in “Kunststoffhandbuch, Band 7, Polyurethane” [Plastics Handbook, volume 7, Polyurethanes], Carl Hanser Verlag, 3rd edition 1993, chapter 3.1. Particular preference is given to using polyesterols or polyetherols as polyols. It is likewise possible to use polycarbonates. It is also possible to use copolymers in the context of the present invention. The number-average molecular weight of the polyols used in accordance with the invention is preferably between 0.5×10³ g/mol and 8×10³ g/mol, preferably between 0.6×10³ g/mol and 5×10³ g/mol, especially between 0.8×10³ g/mol and 3×10³ g/mol.

Preferred polyetherols are, in accordance with the invention, polyethylene glycols, polypropylene glycols and polytetrahydrofurans.

In a particularly preferred embodiment, the polyol is a polytetrahydrofuran having a molecular weight in the Mn range from 600 g/mol to 2500 g/mol.

Also usable in accordance with the invention as well as PTHF are various other polyethers, but also polyesters, block copolymers and hybrid polyols, for example poly(ester/amide).

Preferably, the polyols used have a mean functionality between 1.8 and 2.3, preferably between 1.9 and 2.2, especially 2. Preferably, the polyols used in accordance with the invention have only primary hydroxyl groups.

According to the invention, the polyol may be used in pure form or in the form of a composition comprising the polyol and at least one solvent. Suitable solvents are known per se to those skilled in the art.

The additional polyol is preferably used in a molar ratio in the range from 40:1 to 1:10 relative to the bisphenol derivative. In further preferred embodiments, the polyol and the bisphenol derivative are used in a molar ratio in the range from 30:1 to 1:9, further preferably in the range from 20:1 to 1:8.5, especially in the range from 15:1 to 1:5, more preferably in the range from 10:1 to 1:2, or else in the range from 7:1 to 1:1.6.

According to the invention, at least one polyisocyanate is used. According to the invention, it is also possible to use mixtures of two or more polyisocyanates.

Preferred polyisocyanates in the context of the present invention are diisocyanates, especially aliphatic or aromatic diisocyanates, further preferably aromatic diisocyanates.

In a further embodiment, the present invention accordingly relates to a process as described above, wherein the polyisocyanate is an aromatic diisocyanate.

In addition, in the context of the present invention, it is possible to use prereacted prepolymers as isocyanate components, in which some of the OH components have been reacted with an isocyanate in a preceding reaction step. These prepolymers are reacted with the remaining OH components in a subsequent step, the actual polymer reaction, and then form the thermoplastic polyurethane. The use of prepolymers offers the option of using OH components having secondary alcohol groups as well.

Aliphatic diisocyanates used are standard aliphatic and/or cycloaliphatic diisocyanates, for example tri-, tetra-, penta-, hexa-, hepta- and/or octamethylene diisocyanate, 2-methylpenta-methylene 1,5-diisocyanate, 2-ethyltetramethylene 1,4-diisocyanate, hexamethylene 1,6-diisocyanate (HDI), pentamethylene 1,5-diisocyanate, butylene 1,4-diisocyanate, trimethylhexa-methylene 1,6-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, 4,4′-, 2,4′- and/or 2,2′-methylene dicyclohexyl diisocyanate (H12MDI).

Preferred aliphatic polyisocyanates are hexamethylene 1,6-diisocyanate (HDI), 1-isocyanato-3,3,5-trimethyl-5-isocyanatomethylcyclohexane and 4,4′-, 2,4′- and/or 2,2′-methylene dicyclohexyl diisocyanate (H12MDI); especially preferred are 4,4′-, 2,4′- and/or 2,2′-methylene dicyclohexyl diisocyanate (H12MDI) and 1-isocyanato-3,3,5-trimethyl-5-isocyanatomethyl-cyclohexane or mixtures thereof.

Accordingly, the present invention relates, in a further embodiment, to a process as described above, wherein the polyisocyanate is selected from the group consisting of 4,4′-, 2,4′- and/or 2,2′-methylene dicyclohexyl diisocyanate (H12MDI), hexamethylene diisocyanate (HDI) and 1-isocyanato-3,3,5-trimethyl-5-isocyanatomethylcyclohexane (IPDI) or mixtures thereof.

Suitable aromatic diisocyanates are especially diphenylmethane 2,2′-, 2,4′- and/or 4,4′-diisocyanate (MDI), naphthylene 1,5-diisocyanate (NDI), tolylene 2,4- and/or 2,6-diisocyanate (TDI), 3,3′-dimethyl-4,4′-diisocyanatodiphenyl (TODI), p-phenylene diisocyanate (PDI), diphenylethane 4,4′-diisocyanate (EDI), diphenylmethane diisocyanate, dimethyl diphenyl 3,3′-diisocyanate, diphenylethane 1,2-diisocyanate and/or phenylene diisocyanate.

Preferred examples of higher-functionality isocyanates are triisocyanates, e.g. triphenylmethane 4,4′,4″-triisocyanate, and additionally the cyanurates of the aforementioned diisocyanates, and also the oligomers obtainable by partial reaction of diisocyanates with water, for example the biurets of the aforementioned diisocyanates, and also oligomers obtainable by controlled reaction of semiblocked diisocyanates with polyols having an average of more than 2 and preferably 3 or more hydroxyl groups.

In a further embodiment, the present invention relates to a process as described above, wherein the polyisocyanate is an aliphatic diisocyanate.

According to the invention, the polyisocyanate can be used in pure form or in the form of a composition comprising the polyisocyanate and at least one solvent. Suitable solvents are known to those skilled in the art. Suitable examples are nonreactive solvents such as ethyl acetate, methyl ethyl ketone and hydrocarbon.

According to the invention, it is possible to add further feedstocks in the conversion of the at least one aliphatic polyisocyanate; the at least one chain extender; and the at least one polyol composition, for example catalysts or auxiliaries and additions.

Suitable auxiliaries and additions are known per se to those skilled in the art. Examples include surface-active substances, flame retardants, nucleating agents, oxidation stabilizers, antioxidants, lubricants and demolding aids, dyes and pigments, stabilizers, for example against hydrolysis, light, heat or discoloration, inorganic and/or organic fillers, reinforcers and plasticizers. Suitable auxiliaries and additives can be found, for example, in the Kunststoffhandbuch, volume VII, edited by Vieweg and Höchtlen, Carl Hanser Verlag, Munich 1966 (p. 103-113).

Suitable catalysts are likewise known in principle from the prior art. Suitable catalysts are, for example, organic metal compounds selected from the group consisting of tin organyls, titanium organyls, zirconium organyls, hafnium organyls, bismuth organyls, zinc organyls, aluminum organyls and iron organyls, for example tin organyl compounds, preferably tin dialkyls such as tin(II) isooctoate, tin dioctoate, dimethyltin or diethyltin, or tin organyl compounds of aliphatic carboxylic acids, preferably tin diacetate, tin dilaurate, dibutyltin diacetate, dibutyltin dilaurate, titanic esters, bismuth compounds such as bismuth alkyl compounds, preferably bismuth neodecanoate or the like, or iron compounds, preferably iron(MI) acetylacetonate.

In a preferred embodiment, the catalysts are selected from tin compounds and bismuth compounds, further preferably tin alkyl compounds or bismuth alkyl compounds. Particularly suitable are tin(II) isooctoate and bismuth neodecanoate.

The catalysts are typically used in amounts of 3 ppm to 2000 ppm, preferably 10 ppm to 1000 ppm, further preferably 20 ppm to 500 ppm and most preferably of 30 ppm to 300 ppm.

The process in step (a) can in principle be conducted under reaction conditions known per se.

In a preferred embodiment, the process in step (a) is conducted at elevated temperatures relative to room temperature, further preferably in the range between 50° C. and 200° C., more preferably in the range from 65° C. and 150° C., especially in the range from 75° C. and 120° C.

According to the invention, the heating can be effected by any suitable method known to those skilled in the art, preferably by electrical heating, heating via heated oil or water, induction fields, warm air or IR radiation.

According to the invention, the thermoplastic polyurethanes obtained are processed to give a shaped body (SB*). The process accordingly comprises step (a) and steps (b) to (e). According to the invention, the process may comprise further steps, for example thermal treatments. Preferably, however, the process of the invention comprises exactly steps (a) to (e) without further intermediate steps.

In a further embodiment, the present invention relates to a process as described above, wherein the shaped body (SB) undergoes recovery as a result of heating to a temperature above the switching temperature.

The process of the invention affords a shaped body (SB) having shape memory effect. In a further aspect, the present invention also relates to shaped bodies obtainable or obtained by a process as described above.

In principle, the shaped body (SB) may comprise bodies of all possible shapes, for example extrusion products such as films and other shaped bodies, preferably a film or a tube.

In a further embodiment, the present invention accordingly relates to a shaped body as described above, wherein the shaped body is a tube or a film.

The present invention also further relates to the use of a thermoplastic polyurethane for production of a shaped body having shape memory effect within a temperature range from 20° C. to 120° C., wherein the thermoplastic polyurethane is obtainable or obtained by conversion of at least components (i) to (iii):
(i) a polyisocyanate composition;
(ii) at least one chain extender; and
(iii) at least one polyol composition,
   wherein the polyol composition comprises at least one bisphenol derivative selected from the group consisting of bisphenol A derivatives having a molecular weight Mw>315 g/mol and bisphenol S derivatives having a molecular weight Mw>315 g/mol, where at least one of the OH groups of the bisphenol derivative has been alkoxylated.

In a further embodiment, the present invention accordingly relates to the use of a thermoplastic polyurethane for production of a shaped body having shape memory effect as described above, wherein the shaped body is a shrink tube or a shrink film.

Further embodiments of the present invention can be inferred from the claims and examples. It will be apparent that the aforementioned features of the subject matter/processes/uses of the invention and those that are elucidated hereinafter are usable not just in the particular combination specified but also in other combinations, without leaving the scope of the invention. For example, the combination of a preferred feature with a particularly preferred feature, or that of a feature that has not been characterized further with a particularly preferred feature, etc., is implicitly also encompassed even if this combination is not mentioned explicitly.

Illustrative embodiments of the present invention are listed hereinafter, although these do not restrict the present invention. More particularly, the present invention also encompasses those embodiments which arise from the dependency references and hence combinations cited hereinafter.
1. A process for producing a shaped body (SB) comprising the following steps:
   (a) preparing a thermoplastic polyurethane comprising the conversion of
      (i) at least one polyisocyanate composition;
      (ii) at least one chain extender; and
      (iii) at least one polyol composition,
      where the polyol composition comprises at least one bisphenol derivative selected from the group consisting of bisphenol A derivatives having a molecular weight Mw>315 g/mol and bisphenol S derivatives having a molecular weight Mw>315 g/mol, where at least one of the OH groups of the bisphenol derivative has been alkoxylated;
   (b) producing a shaped body (SB*) from the thermoplastic polyurethane,
   (c) heating the shaped body (SB*) to a temperature below the temperature of permanent deformability of the shaped body (SB*) and above the switching temperature of the thermoplastic polyurethane,
   (d) expanding the heated shaped body (SB*) to obtain a shaped body (SB),
   (e) cooling the shaped body (SB) to a temperature below the switching temperature of the thermoplastic polyurethane.
2. The process according to embodiment 1, wherein the thermoplastic polyurethane is a compact thermoplastic polyurethane.
3. The process according to either of embodiments 1 and 2, wherein the commencement of permanent deformability corresponds to the commencement of melting of the hard phase of the thermoplastic polyurethane, and the switching temperature to the commencement of the highest phase transition in terms of temperature before the melting range.
4. The process according to any of embodiments 1 to 3, wherein the switching temperature of the thermoplastic polyurethane (T_{switch}) is in the range from 20 to 120° C.
5. The process according to any of embodiments 1 to 4, wherein the extent of the shaped body (SB) obtained in step (d) in at least one dimension is at least 150% of the extent of the shaped body (SB*).
6. The process according to any of embodiments 1 to 5, wherein the shaped body (SB*) is produced in step (b) by means of extrusion, injection molding or sintering methods.
7. The process according to any of embodiments 1 to 6, wherein the chain extender used in (i) is a diol having a molecular weight Mw<220 g/mol.
8. The process according to any of embodiments 1 to 7, wherein the chain extender used in (i) and the bisphenol derivative present in the polyol composition are used in a molar ratio of 40:1 to 1:10.
9. The process according to any of embodiments 1 to 8, wherein the at least one bisphenol derivative has the following general formula (I):

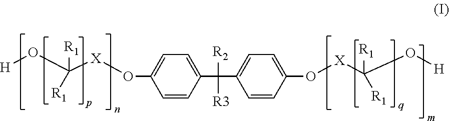

where
R1 is in each case independently a methyl group or H,
R2 and R3 are a methyl group or
R2-C—R3 together are O═S═O,
X is a —C(R1)₂-, —C(R1)₂-C(R1)₂- or —C(R1)₂-C(R1)₂-C(R1)₂- group,
p and q are independently an integer from 1 to 4, and
n and m are independently an integer >0.
10. The process according to any of embodiments 1 to 9, wherein the at least one bisphenol derivative has only primary OH groups.
11. The process according to any of embodiments 1 to 10, wherein the polyol composition comprises a polyol selected from the group consisting of polyetherols, polyesterols, polycarbonate alcohols and hybrid polyols.
12. The process according to any of embodiments 1 to 11, wherein the polyisocyanate is an aromatic diisocyanate.
13. The process according to any of embodiments 1 to 11, wherein the polyisocyanate is an aliphatic diisocyanate.
14. The process according to any of embodiments 1 to 13, wherein the shaped body (SB) undergoes recovery as a result of heating to a temperature above the switching temperature.
15. A shaped body obtainable or obtained by a process according to any of embodiments 1 to 14.
16. The shaped body according to embodiment 15, wherein the shaped body is a tube or a foil.
17. The use of a thermoplastic polyurethane for production of a shaped body having shape memory effect within a temperature range from 20° C. to 120° C., wherein the thermoplastic polyurethane is obtainable or obtained by converting at least components (i) to (iii):
   (i) a polyisocyanate composition;
   (ii) at least one chain extender; and
   (iii) at least one polyol composition,
   wherein the polyol composition comprises at least one bisphenol derivative selected from the group consisting of bisphenol A derivatives having a molecular weight Mw>315 g/mol and bisphenol S derivatives having a molecular weight Mw>315 g/mol, where at least one of the OH groups of the bisphenol derivative has been alkoxylated.
18. The use according to embodiment 17, wherein the shaped body is a shrink tube or a shrink film.

The examples which follow serve to illustrate the invention, but are not restrictive in any way with regard to the subject matter of the present invention.

### EXAMPLES

### 1 The Following Feedstocks were Used

Polyol 1: polyether polyol having an OH number of 113.3 and exclusively primary OH groups (based on tetramethylene oxide, functionality: 2)
Polyol 2: bisphenol A-started polyether polyol having an OH number of 313 and exclusively primary OH groups, functionality: 2
Polyol 3: bisphenol A-started polyether polyol having an OH number of 236 and exclusively primary OH groups, functionality: 2
Polyol 4: polyester polyol based on adipic acid MEG with MW 470 g/mol and an OH number of 240, functionality: 2
Polyol 5: polyester polyol based on phthalic anhydride and DEG with MW 356 g/mol and an OH number of 315
Polyol 6: aromatic polyester polyol with MW 468 g/mol and an OH number of 240
Isocyanate 1: aliphatic isocyanate (4,4′ methylene dicyclohexyl diisocyanate)
Isocyanate 2: aromatic isocyanate (4,4′ methylene diphenyl diisocyanate)
CE: butane-1,4-diol
Catalyst 1: tin(II) isooctoate (50% in dioctyl adipate)
Stabilizer 1: sterically hindered phenol
Additive 1: ester wax

### 2. General Preparation Example

The polyols were initially charged at 80° C. in a vessel and mixed with the components according to table 1 and table 2 with vigorous stirring. The reaction mixture was heated to more than 110° C. and was then poured out onto a heated, Teflon-coated table. The cast slabs obtained were heat-treated at 80° C. for 15 hours, then pelletized and processed by injection molding.

TABLE 1
Compounds used

| Number | Comparative 1 | | Example 1 | | Example 2 | | Example 3 | | Example 4 | | Example 5 | |
|---|---|---|---|---|---|---|---|---|---|---|---|---|
| Polyol 1 [g] | 700 | | 490 | | 280 | | 0 | | 0 | | 420 | |
| Polyol 2 [g] | | | | | | | | | | | 180 | |
| Polyol 3 [g] | 0 | | 210 | | 420 | | 600 | | 600 | | | |
| Isocyanate 1 [g] | 588.00 | | 675.3 | | 763.39 | | 752.81 | | 752.81 | | 624.83 | |
| CE [g] | 183.33 | | 147.72 | | 151.91 | | 147.83 | | 145.22 | | 130.68 | |
| Catalyst 1 | 571 | μL | 609 | μL | 646 | μL | 600 | μL | 599 | μL | 813 | μL |
| Stabilizer 1 [g] | 7.18 | | 7.67 | | | | 7.56 | | 7.54 | | | |
| Additive 1 [g] | 2.87 | | 3.07 | | | | 3.02 | | 3.02 | | | |
| Index | 1000 | | 1000 | | 1020 | | 990 | | 1000 | | 1000 | |
| Hard segment | 37.90% | | 37.90% | | 36.78% | | 38.52% | | 37.91% | | 37.70% | |
| content | | | | | | | | | | | | |
| Initiation | 80° | C. | 80° | C. | 80° | C. | 80° | C. | 80° | C. | 80° | C. |
| temperature | | | | | | | | | | | | |
| Casting | 110° | C. | 110° | C. | 110° | C. | 110° | C. | 110° | C. | 110° | C. |
| temperature | | | | | | | | | | | | |

TABLE 2
Compounds used

| Number | Comparison 2 | Example 6 | Example 7 |
|---|---|---|---|
| Polyol 1 [g] | 800 | 320 | 623.08 |
| Polyol 2 [g] | 0 | 480 | |
| Polyol 3 [g] | | | 126.92 |
| Isocyanate 2 [g] | 400.00 | 561.31 | 690 |
| CE [g] | 71.32 | 80.91 | 157.40 |
| Stabilizer 1 [g] | 12.84 | 14.57 | 16.14 |
| Index | 1000 | 1000 | |
| Hard segment | 21.20% | 21.20% | 37.87% |
| content | | | |
| Initiation | 80° C. | 80° C. | |
| temperature | | | |
| Casting temperature | 110° C. | 110° C. | |

### 3. Mechanical Properties

The measurements compiled in table 3 were established using injection-molded sheets or extrusion products from example 7.

TABLE 3
Mechanical properties for example 7

| Shore D | 62 | |
|---|---|---|
| Tensile strength | 51 | MPa |
| Elongation at break | 390% | |
| Tear propagation resistance | 120 | kN/m |
| Compression set (72 h/23° C./30 min) | 26% | |
| Compression set (24 h/70° C./30 min) | 35% | |
| Compression set (24 h/100° C./30 min) | 49% | |
| Abrasion | 38 | mm³ |
| Burst pressure of heat-treated 5.8 * 8.2 mm hoses at 23° C. | 41.5 | bar |
| Burst pressure of heat-treated 5.8 * 8.2 mm hoses at 70° C. | 20 | bar |
| Switching temperature | 92° | C. |

The following properties of the polyurethanes obtained were determined by the processes mentioned:
Hardness: DIN ISO 7619-1
Tensile strength and elongation at break: DIN 53504
Tear propagation resistance: DIN ISO 34-1, B (b)
Abrasion measurement: DIN ISO 4649
4. Determination of shrinkage characteristics:
   Strips of about 1.5 cm in width and 9.3 cm in length (SB*) were cut out of injection-molded sheets and heated in water at 98° C. Subsequently, the strips are stretched with two pairs of pliers and held in such an elongated state while being cooled down to 30° C., and the shaped body SB is obtained. Thereafter, the shaped body SB is placed back into water at 98° C. and the reset characteristics are observed.
   For various samples, the shrinkage characteristics were determined by the general method of determination. The results are compiled in table 4.

TABLE 4
Shrinkage characteristics of various TPUs

| | | | Observation in hot | |
|---|---|---|---|---|
| | Length after | Stretches | water after | Shrinks |
| Sample | pulling (SB) | to | shrinkage | by |
| Compar- | 9.3 cm (does not | 100% | no shrinkage | 0% |
| ison 1 | soften) | | | |
| Example 1 | 17 cm | 183% | shrinks to 10 cm | 41% |
| Example 2 | 22 cm | 237% | shrinks to 11.3 cm | 49% |
| Example 4 | 25 cm | 269% | shrinks to 11 cm | 56% |
| Example 5 | 20 cm | 215% | shrinks to 10 cm | 45% |
| Compar- | 9.3 cm (does not | 100% | no shrinkage | 0% |
| ison 2 | soften) | | | |
| Example 6 | 24 cm | 258% | shrinks to 10.5 cm | 56% |

1. A process for producing a shaped body (SB), the process comprising:
(a) preparing a thermoplastic polyurethane by conversion of
(i) at least one polyisocyanate composition,
(ii) at least one chain extender, and
(iii) at least one polyol composition,
wherein the polyol composition comprises at least one bisphenol derivative selected from the group consisting of bisphenol A derivatives having a molecular weight Mw>315 g/mol and bisphenol S derivatives having a molecular weight Mw>315 g/mol, wherein at least one of the OH groups of the bisphenol derivative has been alkoxylated, and
wherein the polyol composition comprises at least one further polyol and the at least one further polyol is selected from the group consisting of polyetherols, polyesterols, polycarbonate alcohols and hybrid polyols;
(b) producing a shaped body (SB*) from the thermoplastic polyurethane;
(c) heating the shaped body (SB*) to a temperature below the temperature of permanent deformability of the shaped body (SB*) and above the switching temperature of the thermoplastic polyurethane;
(d) expanding the heated shaped body (SB*) to obtain a shaped body (SB); and
(e) cooling the shaped body (SB) to a temperature below the switching temperature of the thermoplastic polyurethane.

2. The process according to claim 1, wherein the thermoplastic polyurethane is a compact thermoplastic polyurethane.

3. The process according to claim 1, wherein a commencement of permanent deformability corresponds to a commencement of melting of the hard phase of the thermoplastic polyurethane, and a switching temperature corresponds to a commencement of the highest phase transition in terms of temperature before the melting range.

4. The process according to claim 1, wherein the switching temperature of the thermoplastic polyurethane (T_{switch}) is in the range from 20 to 120° C.

5. The process according to claim 1, wherein an extent of the shaped body (SB) obtained in the expanding (d) in at least one dimension is at least 150% of an extent of the shaped body (SB*).

6. The process according to claim 1, wherein the shaped body (SB*) is produced in the producing (b) by extrusion, injection molding or sintering methods.

7. The process according to claim 1, wherein the chain extender used in (i) is a diol having a molecular weight Mw<220 g/mol.

8. The process according to claim 1, wherein the chain extender and the bisphenol derivative present in the polyol composition are used in a molar ratio of 40:1 to 1:10.

9. The process according to claim 1, wherein the at least one bisphenol derivative has the following general formula (I): 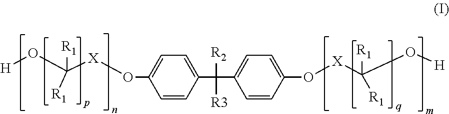
wherein
R1 is in each case independently a methyl group or H,
R2 and R3 are a methyl group or R2-C—R3 together are O═S═O,
X is a —C(R1)₂-, —C(R1)₂-C(R1)₂- or —C(R1)₂-C(R1)₂-C(R1)₂- group,
p and q are independently an integer from 1 to 4, and
n and m are independently an integer >0.

10. The process according to claim 1, wherein the at least one bisphenol derivative has only primary OH groups.

11. (canceled)

12. The process according to claim 1, wherein the polyisocyanate is an aromatic diisocyanate.

13. The process according to claim 1, wherein the polyisocyanate is an aliphatic diisocyanate.

14. The process according to claim 1, wherein the shaped body (SB) undergoes recovery as a result of heating to a temperature above the switching temperature.

15. A shaped body obtainable or obtained by a process according to claim 1.

16. The shaped body according to claim 15, wherein the shaped body is a tube or a film.

17. The shaped body according to claim 15, wherein the shaped body has a shape memory effect within a temperature range from 20° C. to 120° C.

18. The shaped body according to claim 17, wherein the shaped body is a shrink tube or a shrink film.
